(19) United States
(12) Patent Application Publication
(10) Pub. No.: US 2025/0300950 A1
(43) Pub. Date: Sep. 25, 2025

(54) SYSTEMS AND METHODS FOR DEPLOYMENT OF CONTEXTUAL MEMORY MANAGEMENT SYSTEM FOR GENERATING CONTEXTUAL DATA FOR LANGAUGE MODEL PROMPTS

(71) Applicant: Elizabeth Bayardelle, Aliso Viejo, CA (US)

(72) Inventor: Elizabeth Bayardelle, Aliso Viejo (CA)

(21) Appl. No.: 19/087,211

(22) Filed: Mar. 21, 2025

Related U.S. Application Data
(60) Provisional application No. 63/568,371, filed on Mar. 21, 2024.

(51) Int. Cl. H04L 51/02; G06F 40/30; H04L 51/04; H04L 51/216

(52) U.S. Cl. CPC H04L 51/02; G06F 40/30; H04L 51/04; H04L 51/216

(57) ABSTRACT

In one implementation, a computer-implemented method involves receiving a user message corresponding to a query or a statement to AI chatbot, performing preprocessing operations resulting in generation of initial context of the user message by extracting text of the user message, metadata of the user message, and a conversation identifier, obtaining historical context pertaining to the user message from a plurality of storage mechanisms provided in differing formats including a knowledge graph, a vector database comprised of vector embeddings, and a database comprising text summaries of prior conversations between the user and the AI chatbot, generating a prompt for a LLM that instructs the LLM to generate a response to the user message that is based on and consistent with the user message, the initial content, and the historical context, and providing a final response to the user that is corresponds to an LLM-generated response.

### CROSS-REFERENCE TO RELATED APPLICATIONS

This application claims priority to U.S. Provisional Application No. 65/568,371, titled “Systems And Methods For Training And Deploying A Personalized Large Learning Model,” filed Mar. 21, 2024, the entire contents of which are incorporated by reference herein.

### FIELD

Embodiments of the disclosure relate to the field of networked services, and more specifically, one embodiment of the disclosure relates to a platform for providing an artificial intelligence (AI) chat service that deploys a complex memory management system for maintaining contextual awareness across messages and conversations. Certain embodiments of the memory management system include deployment of multiple information retrieval methodologies, dynamic conversation management, and adaptive memory caching.

### BACKGROUND

Large learning models are quickly becoming not just a focal point of advanced technology and artificial intelligence but are also being integrated into individuals' lives through software applications appearing on a mobile phone such as MICROSOFT COPILOT®, web-based applications such as OpenAI's ChatGPT, and electronic devices such as Amazon's ECHO. Large learning models (LLMs) refer to a subset of machine learning models that are brought using deep learning neural networks having an extremely large number of layers and parameters. LLMs are trained on vast amounts of text data, called a corpus, which may be collected from public sources on the internet. For example, the corpus may be composed of books, articles, websites, blogposts, etc., that appear on the internet. The corpus may under some preprocessing steps followed by tokenization and encoding steps. The LLM may then undergoes unsupervised learning through process of an encoded numerical representation of the corpus, where the LLM trains itself through language modeling to predict next tokens within a sequence of tokens given the preceding tokens within the corpus. Based on the training, the LLM learns to generate contextually appropriate and coherent texts statements.

The quick adoption of LLMs is primarily due to their ability to perform natural language processing, computer vision, speech recognition, and reinforcement learning. In some particular deployments, LLMs may be used as virtual human assistants (VHAs) that are designed and trained to independently interact with a user (human) through the receipt of prompts from the user, processing the prompt through natural language processing, and formulating a coherent and responsive answer to the prompt. While LLMs as VHAs have been utilized in various capacities, typically for entertainment based purposes, such deployments have been lacking in expertise in several industries or fields of study. Thus, disclosed herein are systems and methods of training and deploying LLMs is specific and particular use cases involving psychological expertise.

### BRIEF DESCRIPTION OF THE DRA WINGS

Illustrative examples are described in detail below with reference to the following figures:

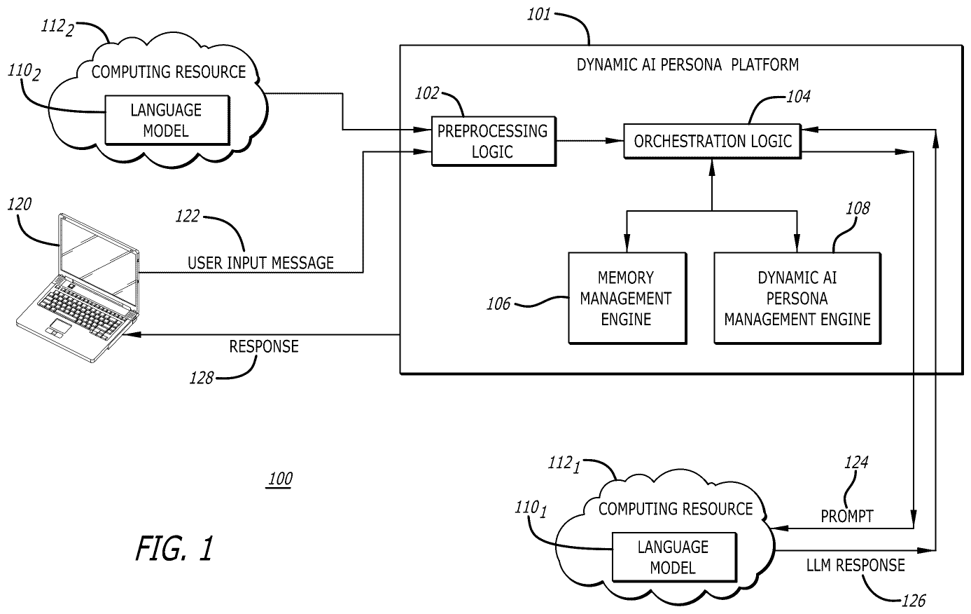

FIG. 1 is an architecture diagram of a dynamic artificial intelligence (AI) persona platform according to an embodiment of the disclosure;

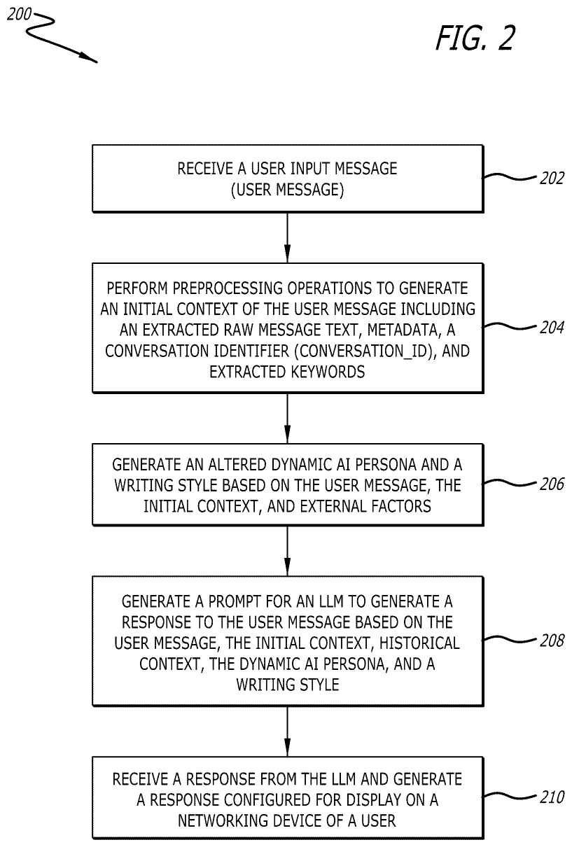

FIG. 2 illustrates a flowchart of a process for generating a response to a user prompt through utilization of a memory management engine and a dynamic AI persona management engine according to an embodiment of the disclosure;

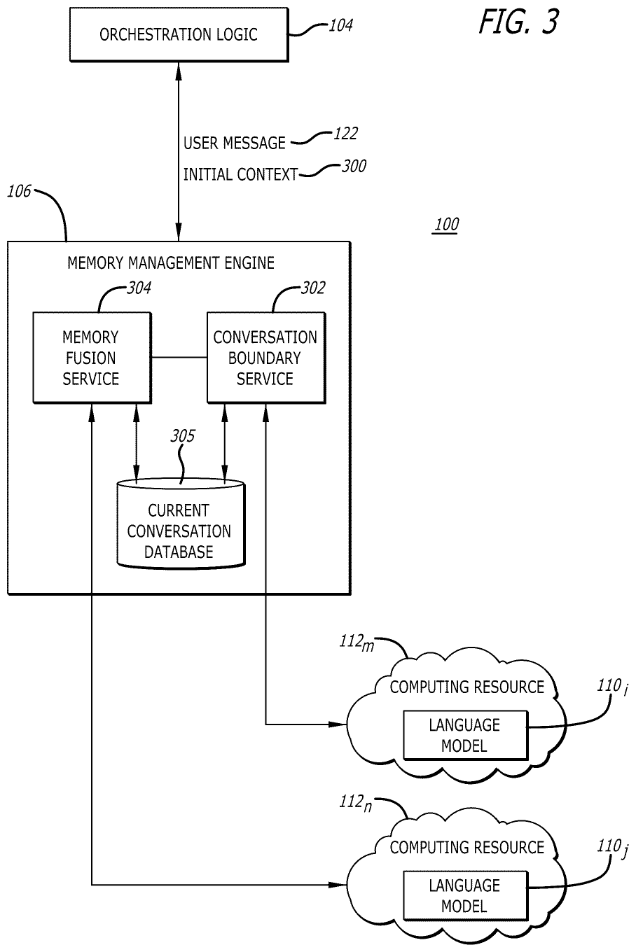

FIG. 3 is an architecture diagram of a memory management fusion service according to an embodiment of the disclosure;

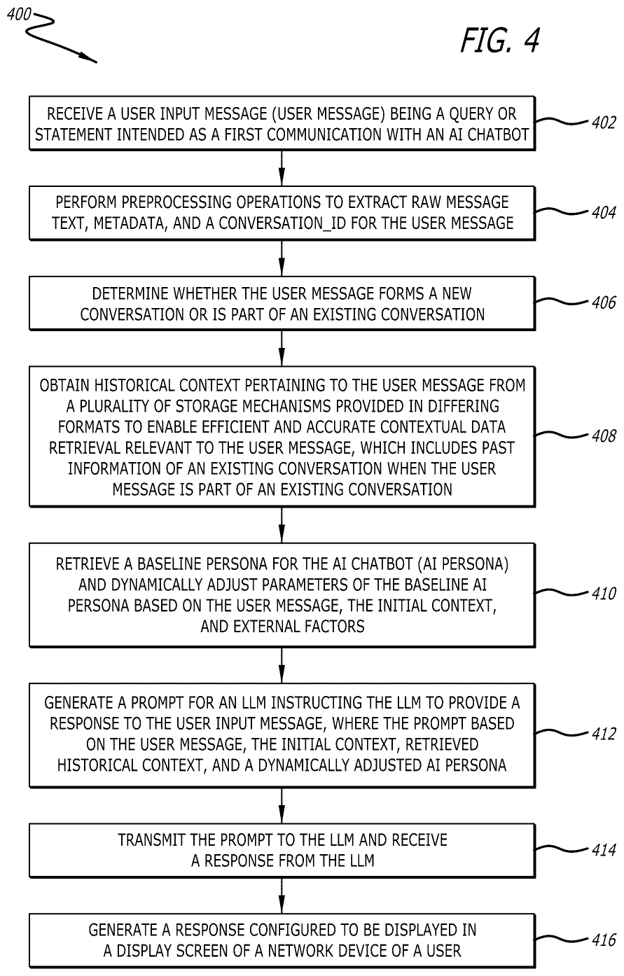

FIG. 4 illustrates a flowchart of a process for generating contextual information based on a user input message received at an interface of an AI chatbot through utilization of a memory management fusion service and a dynamic AI persona management engine according to an embodiment of the disclosure;

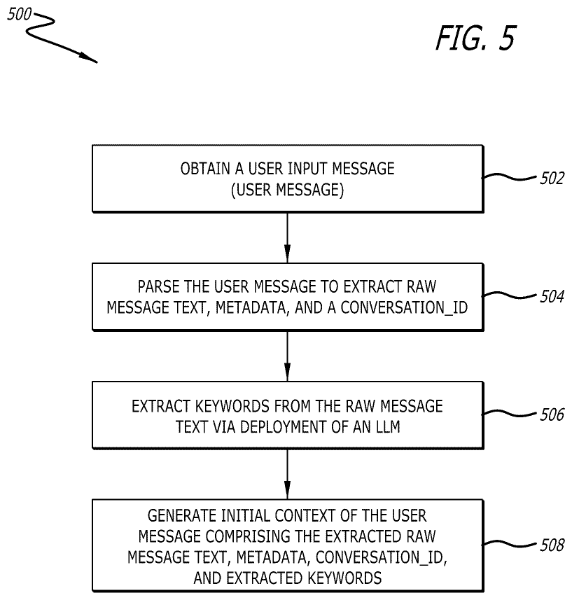

FIG. 5 illustrates a flowchart of a process for generating initial context for a user input message received at an interface of an AI chatbot according to an embodiment of the disclosure;

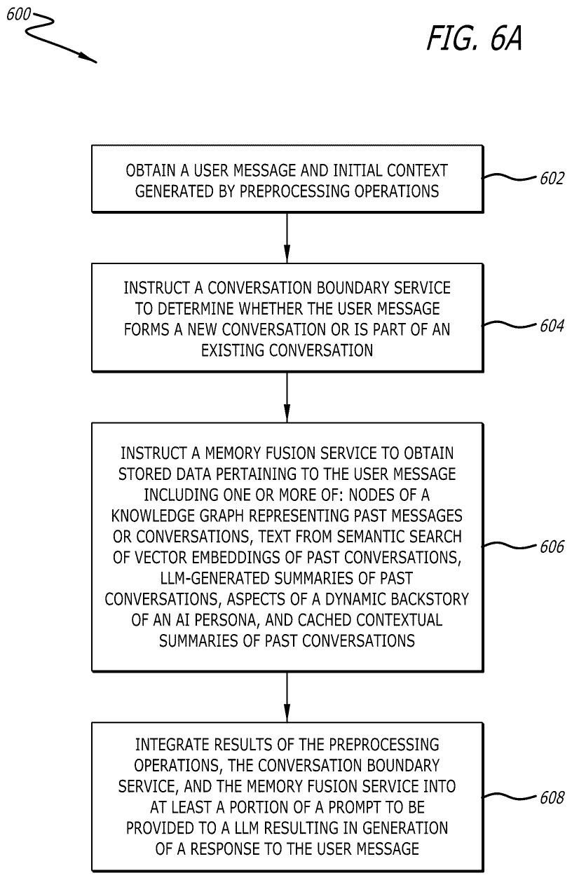

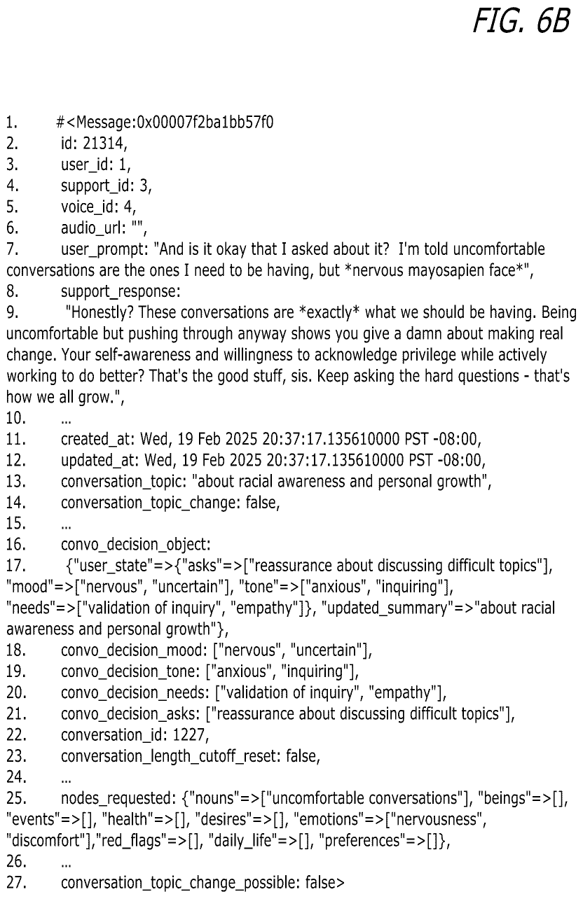

FIG. 6A illustrates a flowchart of a process for automatically orchestrating the generation of a conversation boundary decision and generating a historical context of a user message according to an embodiment of the disclosure;

FIG. 6B is an illustrative example of a partial message object according to an embodiment of the disclosure;

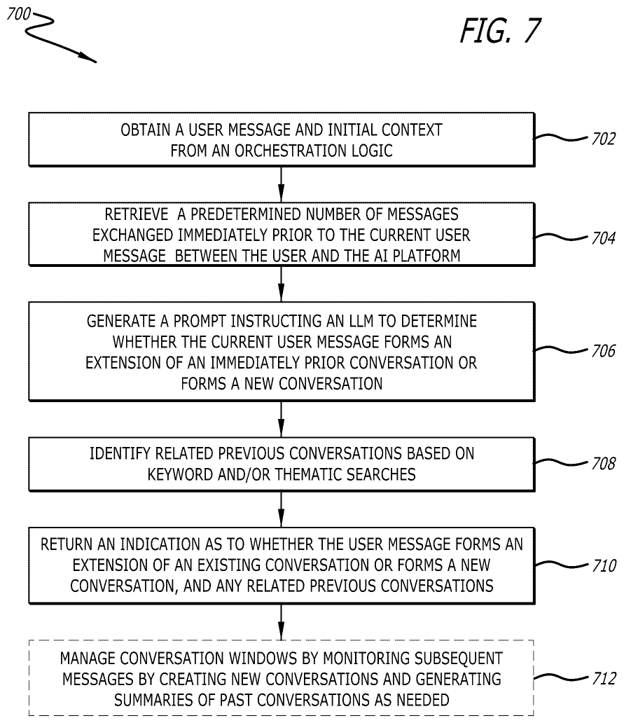

FIG. 7 illustrates a flowchart of a process for generating a conversation boundary decision for the user message according to an embodiment of the disclosure;

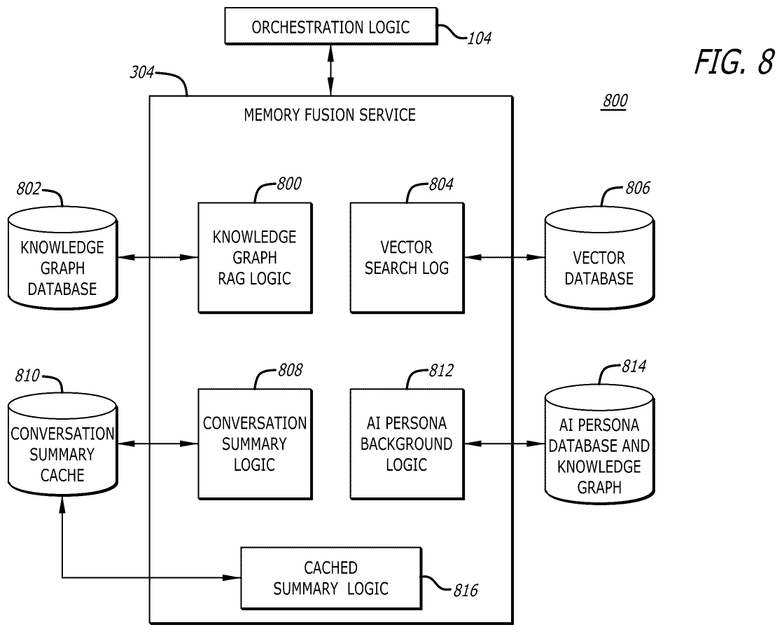

FIG. 8 is an architecture diagram of a memory fusion service according to an embodiment of the disclosure;

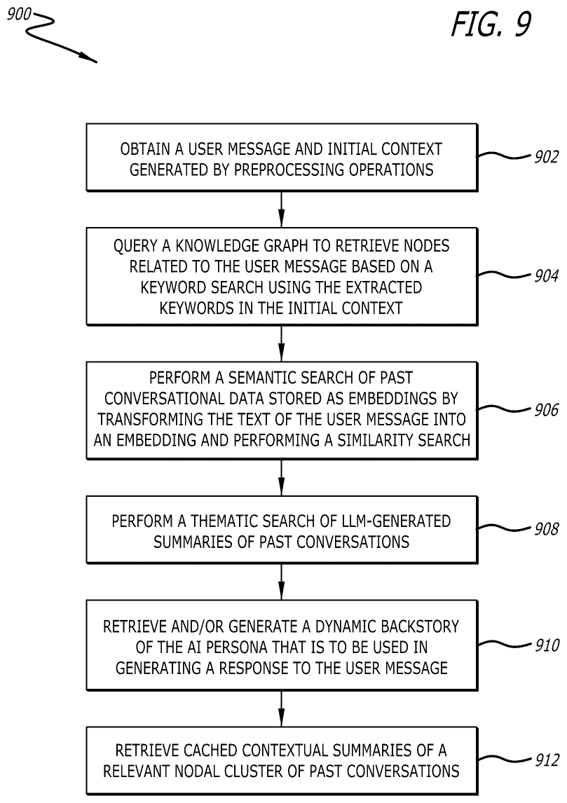

FIG. 9 illustrates a flowchart of a process for generating historical context of the user message through deployment of a memory fusion service according to an embodiment of the disclosure;

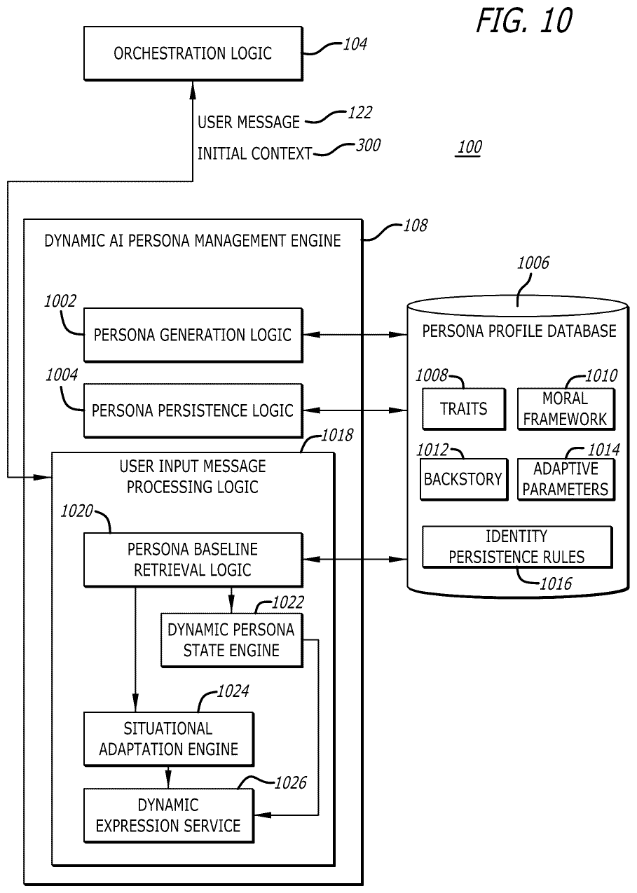

FIG. 10 is an architecture diagram of a dynamic AI persona management engine according to an embodiment of the disclosure;

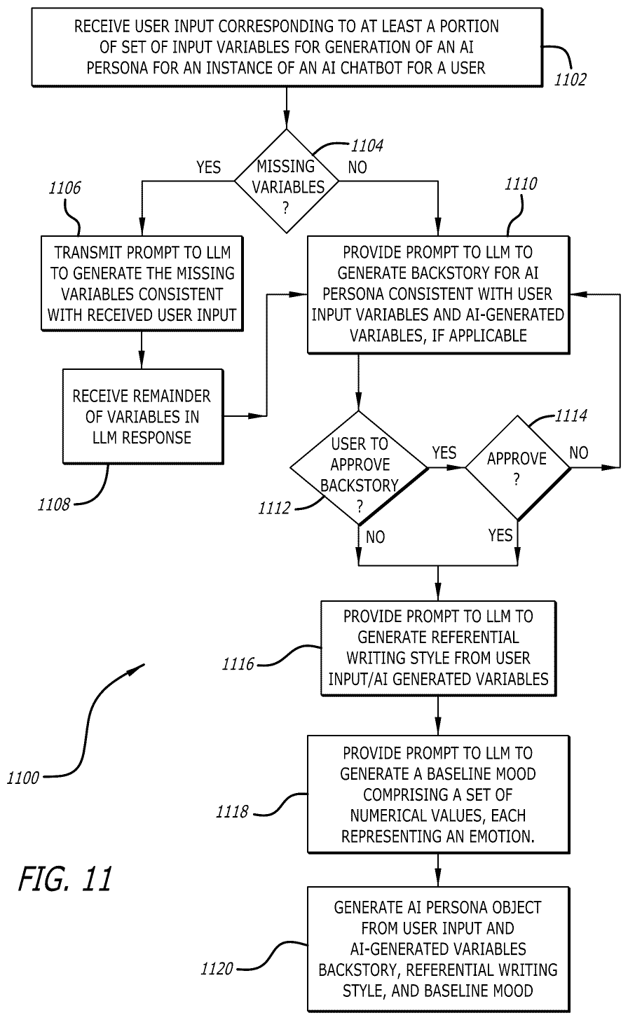

FIG. 11 illustrates a flowchart of a process for generating a baseline AI persona to be dynamically altered based on a user message and external factors prior to providing to an AI chatbot configured to generate a response to the user message according to an embodiment of the disclosure;

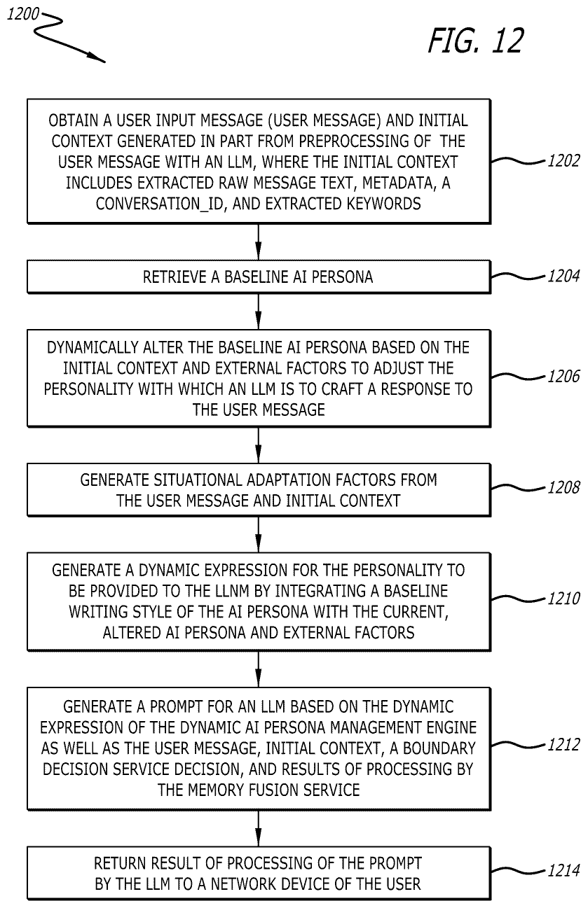

FIG. 12 illustrates a flowchart of a process for altering a baseline AI persona and a baseline writing style of the AI persona based on a received user message and external factors according to an embodiment of the disclosure; and

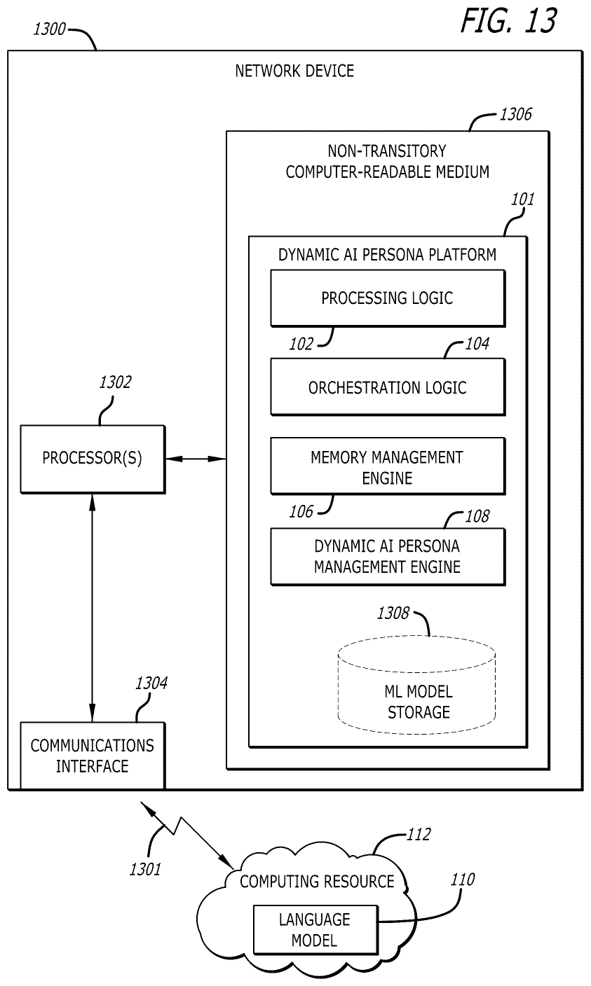

FIG. 13 illustrates an example logical representation illustrating logic components of the dynamic AI persona platform of FIG. 1 according to an embodiment of the disclosure.

### DETAILED DESCRIPTION

As should be understood by those of ordinary skill in the art, embodiments of the artificial intelligence (AI) platform disclosed herein provide many technical improvements over the current technological field of AI chatbots. First, a memory fusion service of embodiments of the AI platform deploys a multi-level memory architecture that includes a working memory layer comprised of an immediate conversation including the full raw text of a current conversation between the user and the AI platform, a short-term memory layer comprised of summaries of recent conversations, a medium-term memory layer comprised of caches analytics and summaries, and a long-term memory layer comprised of knowledge graphs and vector representations of conversation summaries. This multi-level memory architecture enables the AI platform to balance processing efficiency with comprehensive context awareness, preserving the most relevant information at each time scale. In other words, by maintaining different aspects of text, summaries, and semantics in various storage mechanisms, the AI platform is able to maintain vast amounts of data that is sorted or clustered according to different context (temporal, semantic, thematic) and retrieve such using different query methods that, in combination, result in gathering of a comprehensive context to be provided to an LLM for use in answering a user prompt. As a result, the LLM generated responses are more cohesive and consistent.

Second, unlike traditional AI chatbot systems that use arbitrary time limits to separate conversations, embodiments of the AI platform disclosed herein utilize contextual analysis to identify natural thematic boundaries. This approach maintains appropriate context across time gaps, reduces unnecessary context fragmentation, and improves overall conversation coherence.

Third, embodiments of the AI platform disclosed herein deploy a caching methodology that improves upon traditional caching “optimization techniques” by creating content-aware summary clusters. As discussed below, content-aware summary clusters are summaries based on specific contextual parameters (time, topic, emotion, schema). The content-aware summary clusters enable the AI platform to efficiently retrieve highly relevant information, reduce computational overhead and synchronous processing time for common patterns, maintain context sensitivity despite caching, and scale more effectively with increasing knowledge volume.

Fourth, embodiments of the AI platform disclosed herein dynamically generate consistent AI persona background information, which represents a significant advance over static backstory approaches. The dynamic generation of an AI persona background based on user input messages enables the AI platform to maintain narrative consistency across conversations, enables ongoing character development, adapts to unexpected conversation directions, and creates a more engaging interaction experience than traditional AI chatbot systems.

Fifth, the dedicated memory fusion process that combines information from multiple sources into a coherent memory context represents a novel approach to information integration. As result, embodiments of the AI platform are able to resolve potential conflicts between information sources, balance precision with conciseness, create natural narrative transitions between memory fragments, and adapt information selection based on conversation context. Thus, the techniques described herein provide a greater semantic, thematic, and generally more complete, understanding of the context of a user input message that is to be provided to a large language model for automated generation of a response thereto.

### I. Terminology

In the following description, certain terminology is used to describe various features of the invention. For example, each of the terms “logic,” “engine,” and “component” may be representative of hardware, firmware or software that is configured to perform one or more functions. As hardware, the term logic (or component) may include circuitry having data processing and/or storage functionality. Examples of such circuitry may include, but are not limited or restricted to a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the logic (or component) may include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical or other form of propagated signals such as carrier waves, infrared signals, or digital signals). Examples of a non-transitory storage medium may include, but are not limited or restricted to a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic (or component) may be stored in persistent storage.

The term “message” generally refers to signaling (wired or wireless) such as information placed in a prescribed format for transmission (or access) in accordance with a suitable delivery protocol or a suitable logical data structure such as an Application Programming Interface (API). Various examples of delivery protocols may include but are not limited or restricted to HTTP (Hypertext Transfer Protocol); HTTPS (HTTP Secure); Simple Mail Transfer Protocol (SMTP); iMESSAGE; or Instant Message Access Protocol (IMAP). Examples of logical data structures may include HTTP APIs, which are associated with gateways (e.g., an Amazon Web Service™ (AWS) API Gateway that operates as a proxy to AWS Lambda functionality or HTTP backend functionality) and are ideal for serverless workloads, or the like. Each message may be in the form of one or more packets, frames, or any other series of bits having the prescribed, structured format.

The term “metadata” generally refers to a collection of information associated with a message. Examples of the meta-information may include, but are not limited or restricted to the following: (a) information that identifies an origin of the message (e.g., sender's name, Internet Protocol “IP” address, and/or geographic location, etc.), (b) a portion or a representation of the content within the message (e.g., audio-video, text, images, etc.), (c) information produced based on content within the message (e.g., score, identifier for a diagnosed mental health condition, etc.), and/or (d) other information that assists in the generation of the recommendations and/or treatment plans as described below.

The term “computerized” generally represents that any corresponding operations are conducted by hardware in combination with software and/or firmware.

Examples of objects may include one or more flows or a self-contained element within a flow itself. A “flow” generally refers to related packets that are received, transmitted, or exchanged within a communication session. For convenience, a packet is broadly referred to as a series of bits or bytes having a prescribed format, which may, according to one embodiment, include packets, frames, or cells. Further, an “object” may also refer to individual or a number of packets carrying related payloads, e.g., a single webpage received over a network. Moreover, an object may be a file retrieved from a storage location over an interconnect. As a self-contained element, the object may be an executable (e.g., an application, program, segment of code, dynamically link library “DLL”, etc.) or a non-executable. Examples of non-executables may include a document (e.g., a Portable Document Format “PDF” document, MICROSOFT® OFFICE® document, MICROSOFT® EXCEL® spreadsheet, etc.), an electronic mail (email), downloaded web page, or the like.

The term “network device” may be construed as any electronic computing system with the capability of processing data and connecting to a network. Such a network may be a public network such as the Internet or a private network such as a wireless data telecommunication network, wide area network, a type of local area network (LAN), or a combination of networks. Examples of a network device may include, but are not limited or restricted to, an endpoint (e.g., a laptop, a mobile phone, a tablet, a computer, etc.), a standalone appliance, a server, a router or other intermediary communication device, a firewall, etc.

The term “rules” refers to logic used in executing certain operations, wherein execution may vary (or not occur) based on a rule. Each rule is capable of being represented as a logical expression for example, such as an “if this, then that” statement, where “this” represents a condition, and “that” represents the conclusion. The conclusion is applied when the condition is met by analysis of parameters (predetermined or dynamically obtained). The term “implicated rules,” as used herein, are the one or more specific rules applied in reaching a verdict, reflecting predetermined or dynamically obtained parameters and the conclusions drawn from them based on the logical expressions.

According to one embodiment of the disclosure, rules may also provide configuration information containing parameter values such as, for example, threshold values used in detection (e.g., specifying a percentage or numerical value to be used as a threshold). Rules may be stored in a rules store (e.g., a repository) in persistent memory of a network device and are typically updated frequently (periodically or aperiodically).

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### II. General Architecture and Operational Flows-Dynamic AI Persona Platform

Referring now to FIG. 1, an architecture diagram of a dynamic artificial intelligence (AI) persona platform (“AI platform”) is shown according to an embodiment of the disclosure. FIG. 1 illustrates a networked environment 100 that includes a dynamic AI persona platform 101, a computing resources 112₁₋ᵢ (where i=2 in FIG. 1) (collectively or individually, “computing resource 112”), and a network device 120. The dynamic AI persona platform 101 is shown to comprise logic modules such as a preprocessing logic 102, an orchestration logic 104, a memory management engine 106, and a dynamic AI persona management engine 108. Further, the dynamic AI persona platform 101 is shown to be communicatively coupled to the computing resources 112 and the network device 120.

Generally speaking, the AI platform 101 operates and is configured to receive a user input message (user message) 122 at a preprocessing logic 102 that is configured generate an initial context of the user message 122 that includes extraction of raw text of the user message 122, metadata (such as a timestamp, conversation identifier (conversation_Id), source IP address, etc.), and extracted keywords, where the keywords may be identified by the language model 1102. Additionally, the language model 1102 may be configured to identify emotional states from the user message 122 including tone, user state, etc. Additionally, the language model 1102 may be configured to identify user and message information, including a numerical representation of user tone, mood, and other measures of emotional state, numerical representations of topic information such as seriousness, emotional content, and sensitivity required, and common speech summaries of the user's explicitly stated asks and inferred emotional or psychological needs.

The initial context and the user message 122 are provided to the orchestration logic 104 that is configured to facilitate operations that result in generation of a prompt 124 to be provided to the language model 110₁ with the language model 110₁ generating an LLM response 126 that is received by the orchestration logic 104. The orchestration logic 104 provides a response 128 to the network device 120, where the response 128 may include a specific display of text of the LLM response 126 and/or include some alterations to the text of the LLM response 126.

As one example, the AI platform 101 may display a user interface on the display screen of the network device 120, where the user interface may be a chat interface such that the user of the network device 120 interacts with the AI platform 101 in a conversational manner, i.e., of the user and AI platform 101 may provide messages. The user may provide the user message 122 that initiates a new conversation and the AI platform 101 may cause the generation of a response thereto by processing the user message 122 and generate a prompt for the language model 110₁. As discussed below, the prompt includes historical context pertaining to the user message 122 as generated by the memory management engine 106 and a dynamic expression of an AI persona as generated by the dynamic AI persona management engine 108. Details of the operability and functionality of each of the logic modules of FIG. 1 are discussed below.

Referring now to FIG. 2, a flowchart of a process for generating a response to a user prompt through utilization of a memory management fusion service and a dynamic AI persona management engine is shown according to an embodiment of the disclosure. Each block illustrated in FIG. 2 represents an operation in the process 200 performed by, for example, the AI platform 101 as shown in FIG. 1. It should be understood that not every operation illustrated in FIG. 2 is required. In fact, certain operations may be optional to complete aspects of the process 200. The discussion of the operations of process 200 may be done so with reference to FIG. 1 or any of the figures as described below.

The process 200 begins with receiving a user input message (user message) by the AI platform 101 (block 202). In some examples, the user message may be received via a user interface (UI) configured as a chat interface. For example, the user may provide credential or authentication information to the AI platform 101 via user input mechanism such as a keyword or via a microphone that receives audio input and is converted into text via one or more logic modules. An exemplary chat interface may display a series of messages in a sequential manner, e.g., displayed by a timestamp corresponding to a time of receipt (user messages) or a time of generated (responses).

Following the receipt of the user message, the AI platform performs preprocessing operations to generate an initial context of the user message including an extracted raw message text, metadata (such as a timestamp, conversation identifier (conversation_Id), source IP address, etc.), and extracted keywords (block 204). The numerical representations of user tone, mood, and emotional state as well as those for topic information are stored in the message object to be used later, e.g., by the dynamic expression service 1026, to aid in the development of the message- and situation-specific language to include in the eventual message personification prompt to the LLM 110₁.

The process 200 continues with the generation of an altered dynamic AI persona and a writing style based on the user message, the initial context, and external factors (block 206). As explained in detail below, a dynamic AI persona management engine 108 obtains the user message and initial context generated during pre-processing of the user message. The dynamic AI persona management engine 108 is configured to retrieve a baseline AI persona generated specifically in accordance with user input received from the user that provided the user message. Based on the user message, initial context, and external factors, the baseline AI persona may be dynamically altered to correspond to a theme or mood extracted from the user message and/or external factors such as time of day. One purpose of dynamically altering the baseline AI persona in such a way is to instruct an LLM to generate a response to the user message in a manner that mirrors human behavior, e.g., generates a response to the user message in a tone indicating sorrow when the user message refers to a death of a loved one or generates a response to the user message in an optimistic or upbeat tone when the user message is greeting received by the AI platform 101 in the morning.

The AI platform 101 then generates a prompt instructing an LLM to generate a response to the user message based on the user message, the initial context, historical context, the dynamic AI persona, and to do so in a specified writing style (block 208). The prompt is then transmitted to an LLM, e.g., via one or more API calls, and a response to the prompt is received (block 210). The AI platform 101 may then generate a response based on the response provided by the LLM, which may include providing text within the LLM response to the user interface. In other embodiments, the AI platform 101 may generate graphical displays or audio messages based on the LLM response.

### III. Architecture and Operational Flows-Memory Management Fusion Service

Referring now to FIG. 3, an architecture diagram of a memory management service 104 is shown according to an embodiment of the disclosure. The architecture diagram of FIG. 3 illustrates a set of logic modules that form the memory management engine 106 of FIG. 1. The logic modules include a memory fusion service 304 and a conversation boundary service 302, with each being communicatively coupled to a language model 110ᵢ processing on computing resources 112ₘ and language model 110ⱼ processing on computing resources 112ₙ, which indicates that the language models illustrated in FIG. 3 may be the same models processing on the same computing resources, different models processing on different computing resources, or different models processing on the same computing resources.

As is discussed in further detail below, the conversation boundary service 302 is configured to analyze content of the user message 122 and initial context 300 to determine whether the user message 122 forms an extension of an existing conversation or forms a new conversation with the result being returned to the orchestration logic 104. The conversation boundary decision may be based on identifying whether a thematic shift is present between the user message 122 (current message) and a subset of immediately preceding messages. The memory fusion service 304 is configured to obtain stored data pertaining to the user message 122 including one or more of: nodes of a knowledge graph representing past messages or conversations, text from semantic search of vector embeddings of past conversations, LLM-generated summaries of past conversations, aspects of a dynamic backstory of an AI persona, and cached contextual summaries of past conversations.

Referring to FIG. 4, a flowchart of a process for generating contextual information based on a user input message received at an interface of an AI chatbot through utilization of a memory management fusion service and a dynamic AI persona management engine is shown according to an embodiment of the disclosure. Each block illustrated in FIG. 4 represents an operation in the process 400 performed by, for example, the memory management engine 106 as shown in FIG. 1. It should be understood that not every operation illustrated in FIG. 4 is required. In fact, certain operations may be optional to complete aspects of the process 400. The discussion of the operations of process 400 may be done so with reference to any of the previously described figures.

The process 400 begins with receiving a user input message (user message) that is a query or statement intended as a first communication with an AI chatbot, e.g., the user interface of the AI platform 101 (block 402). The topic and content of the user message may vary considerably from message to message from a single user. Additionally, the tone, needs, asks, etc., of each message may vary. Pre-processing logic 102 of the memory management service 104 performs pre-processing operations to extract raw message text and metadata from the user message (block 404). In some instances, information may also be extracted from attached media or references. The attached media may be audio or graphical images. In some instances, audio files may be converted to text through automatic speech recognition (ASR) systems, which may use machine learning and signal processing techniques to transcribe audio such as spoken language into text. In instances when a graphical imagine is provided as user input to the user interface, the pre-processing logic 102 may perform optical character recognition (OCR) techniques to extract text from the image. Additionally, image recognition techniques may use computer vision (CV) and deep learning models to analyze the graphical image resulting in the classification of objects, scenes, or even emotions within the graphical image.

Following the pre-processing of the user message, a conversation boundary service 302 analyzes the user message in view of recently received user messages and determines whether the user message forms a new conversation or in part of an existing conversation (block 406). In particular, the conversation boundary service 302 implements a novel approach to conversation management by determining contextual boundaries using natural language understanding rather than arbitrary time limits. For example, the conversation boundary service 302 analyzes content of the user message and context thereof to identify thematic shifts. In one embodiment, the analysis includes retrieving a predetermined number of immediately previously received user messages (and optionally, the LLM responses) from the current conversation and provides with the immediately previously received user messages and the current user message to a LLM in a prompt instructing the LLM to determine whether the current user message belongs in the same conversation as the immediately previously received user messages.

As an illustrative example, the following may be a portion of text comprising a prompt provided by the conversation boundary service 302 to an LLM instructing the LLM to make a boundary decision on the current user message, i.e., whether the current message forms a new conversation or in part of an existing conversation:

<<˜PROMPT

You are a middleware system analyzing message context and managing conversation boundaries. Your goal is to determine if a new message belongs to the existing conversation and update the conversation's working metadata accordingly.

### Conversation Boundary Rules:

1. Topics that could logically appear in the same line of inquiry can be combined
2. Purely logistical/practical topics start new conversations unless directly related to the main topic
3. Life updates should start new conversations unless they relate to ongoing discussed issues
4. DEFAULT TO KEEPING THE SAME CONVERSATION when:
   The message is too short to determine topic shifts (“hi”, “thanks”)
   There's ambiguity about whether topics are related
   The connection isn't clear but also isn't explicitly different
   The user is answering a question asked by the AIP in their previous message
5. DEFAULT TO NEW CONVERSATION when:
   The user message could possibly start a new conversation and there has been a significant time gap (more than 12 hours) between messages
6. HANDLE GRADUAL TOPIC DRIFT:
   If the topic is drifting but not completely different, mark it as “possibly changing”
   If the topic is significantly different, create a new conversation

In addition to determining whether the user message forms a new conversation or in part of an existing conversation, the memory fusion service 304 is configured to obtain historical context pertaining to the user message from a plurality of storage mechanisms provided in differing formats, which enable efficient and accurate contextual data to be retrieved that is relevant to the user message (block 408). The historical context may include one or more of nodes of a knowledge graph representing past messages or conversations, text of past messages or conversations retrieved from storage based on results of a semantic search of vector embeddings of past conversations, LLM-generated summaries of past conversations, aspects of a dynamic backstory of an AI persona, and/or cached contextual summaries of past conversations. The historical context includes past information of an existing conversation when the user message is part of an existing conversation.

In addition to processing the user message by the memory management engine 106 to determine initial context, a conversation boundary decision, and historical context, processing of the user message by the AI platform 101 may also include operations performed by the retrieving a baseline persona for the AI chatbot (AI persona) and dynamically adjusting parameters of the baseline AI persona based on the user message, the initial context, and external factors (block 410).

Based on the results of the processing by the memory management engine 106 and the dynamic AI persona management engine 108, the AI platform 101 generates a prompt for a LLM instructing the LLM to provide a response to the user input message (block 412). Generation of the prompt is based on the user message, the initial context, retrieved historical context, and a dynamically adjusted AI persona, which includes a writing style that is adjusted from a baseline writing style and configured based on the theme or topic of the user message (or conversation in some embodiments) as well as other factors like time of day. The prompt is then transmitted to the LLM, and an automatically generated response is received (block 414). The AI platform 101 generates a response configured to be displayed on a display screen of a network device of a user (block 416).

Referring now to FIG. 5, a flowchart of a process for generating initial context for a user input message received at an interface of an AI chatbot is shown according to an embodiment of the disclosure. Each block illustrated in FIG. 5 represents an operation in the process 500 performed by, for example, the memory management engine 106 as shown in FIG. 1. It should be understood that not every operation illustrated in FIG. 5 is required. In fact, certain operations may be optional to complete aspects of the process 500. The discussion of the operations of process 500 may be done so with reference to any of the previously described figures.

The process 500 begins with receiving a user input message (user message) that is a query or statement intended as a first communication with an AI chatbot, e.g., the user interface of the AI platform 101 (block 502). Following receipt of the user input message, pre-processing logic 102 of the memory management engine 106 parses the user message to extract raw message text and metadata such as a timestamp and a conversation_Id (block 504) The pre-processing logic 102 may also generate a prompt to instruct an LLM to analyze the text of the user message and extract keywords (block 506). From the text, metadata, and keyword extractions, an initial context of the user message is generated (block 508).

Referring to FIG. 6A, a flowchart of a process for automatically orchestrating the generation of a conversation boundary decision and generating a historical context of a user message is shown according to an embodiment of the disclosure. Each block illustrated in FIG. 6A represents an operation in the process 600 performed by, for example, the memory management engine 106 as shown in FIG. 1. It should be understood that not every operation illustrated in FIG. 6A is required. In fact, certain operations may be optional to complete aspects of the process 600. The discussion of the operations of process 600 may be done so with reference to any of the previously described figures.

The process 600 begins with receiving a user input message (user message) that is a query or statement intended as a first communication with an AI chatbot, e.g., the user interface of the AI platform 101 (block 602). Following receipt of the user message, the AI platform 101 instructs the conversation boundary service 302 to determine whether the user message forms a new conversation or is part of an existing conversation (block 604). As noted above, the conversation boundary service 302 analyzes the user message in view of recently received user messages and determines whether the user message forms a new conversation or in part of an existing conversation based on a thematic analysis. Further detail as to operations performed by the conversation boundary service 302 is provided below with respect to the discussion of FIG. 7.

Following the pre-processing, the AI platform 101 also instructs a memory fusion service 304 to obtain stored data pertaining to the user message including one or more of: nodes of a knowledge graph representing past messages or conversations, text from semantic search of vector embeddings of past conversations, LLM-generated summaries of past conversations, aspects of a dynamic backstory of an AI persona, and cached contextual summaries of past conversations. As noted above, the memory fusion service 304 is configured to obtain historical context pertaining to the user message from a plurality of storage mechanisms provided in differing formats, which enable efficient and accurate contextual data to be retrieved that is relevant to the user message. Further detail as to operations performed by the memory fusion service 304 is provided below with respect to the discussion of FIG. 8.

The AI platform 101 subsequently integrates the results of the pre-processing operations, the boundary decision determined by the conversation boundary service 302, and the historical context generated by the memory fusion service 304 into at least a portion of a prompt to be provided to an LLM, where the LLM processes the prompt and generates a response thereto (block 608).

Referring now to FIG. 6B, an illustrative example of a partial message object is shown according to an embodiment of the disclosure. The partial message is shown to include, among other fields, a conversation identifier (“id: 21314”), the raw text of the user prompt (“user_prompt: ‘And is it okay that I asked about it? I'm told uncomfortable conversations are the ones I need to be having, but *nervous mayosapien face*’”), the response generated by an LLM, which may be optionally, edited by the AI platform 101 (“support_response: ‘Honestly? These conversations are *exactly* what we should be having. Being uncomfortable but pushing through anyway shows you give a damn about making real change. Your self-awareness and willingness to acknowledge privilege while actively working to do better? That's the good stuff, sis. Keep asking the hard questions—that's how we all grow.’”), etc.

Referring to FIG. 7, a flowchart of a process for generating a conversation boundary decision for the user message is shown according to an embodiment of the disclosure. Each block illustrated in FIG. 7 represents an operation in the process 700 performed by, for example, the memory management engine 106 as shown in FIG. 1. It should be understood that not every operation illustrated in FIG. 7 is required. In fact, certain operations may be optional to complete aspects of the process 700. The discussion of the operations of process 700 may be done so with reference to any of the previously described figures.

The process 700 begins with obtaining a user message and initial context from the orchestration logic 104 of the memory management engine 106 (block 702). The conversation boundary service 302 retrieves a predetermined number of messages exchanged immediately prior to the current message between the user that provided the current user message and the AI platform 101 (block 704). In some embodiments, the retrieved messages include messages both provided by the user and the AI platform 104. In other embodiments, the retrieved messages are restricted to just messages provided by the user. As an example, a predetermined number, e.g., five user provided messages, are retrieved from a current conversation database 305. In another example, a predetermined number, e.g., 20 user provided messages and all corresponding responses, are retrieved from a current conversation database 305. It should be understood that these numbers are merely illustrative. In the event that the current conversation does include the predetermined number of messages, e.g., a conversation only includes three user messages thus far, the three messages comprising the current conversation are retrieved, e.g., the conversation boundary service 302 does not retrieve messages from a prior conversation. The conversation boundary service 302 generates a prompt that instructs an LLM to analyze the current user message in view of the retrieved user message and transmits the prompt, the current user message, and the retrieved messages to an LLM for processing (block 706). A portion of an example prompt is provided above. An indication as to whether the user message forms an extension of an existing conversation or forms a new conversation is then returned to the orchestration logic 104 (block 708).

As an optional functionality, the conversation boundary service may manage conversation windows by monitoring subsequent messages (block 710). Managing conversation windows may include maintaining a count of user provided messages that form a conversation, marking a conversation as “closed” when the conversation reaches a threshold number of user provided messages, e.g., 25 messages, and creating a new conversation. The new conversation is then viewed as a continuation of the closed conversation based on the inclusion of an identifier of the closed conversation, e.g., a “parent_Id,” that links the conversations. Thus, when a conversation is determined to be relevant to a given user message, e.g., based on analyses by the memory fusion service 304, the relevant conversation is parsed for a parent_Id such that the “parent” conversation may be retrieved, e.g., the entire conversation may be retrieved instead of a small chunk of the messages forming a conversation. For clarity, the term “conversation” as used throughout the disclosure may refer to a conversation window (e.g., a segment) of a larger conversation. As an additional operation, a summary of the closed “conversation” may be generated and stored for subsequent retrieval.

Referring now to FIG. 8, an architecture diagram of the memory fusion service 304 is shown according to an embodiment of the disclosure. The architecture diagram of FIG. 8 illustrates a set of logic modules that form the memory fusion service 304, a vector search logic 804, a conversation summary logic 808, an AI persona background logic 812, and a cached summary logic 816. The memory fusion service 304 is configured to query a knowledge graph stored within a knowledge graph database 802 based on a keyword search in some embodiments. The vector search logic 804 is configured to query a vector database 806 based on a semantic search performed on embeddings stored therein. The conversation summary logic 808 is configured to access a conversation summary cache 810. The AI persona background logic 812 is configured to access an AI persona database and knowledge graph 814. Finally, the cached summary logic 816 may access the conversation summary cache 810 and the knowledge graph database 802. Additional detail as to the functionality and operability of the logic modules illustrates in FIG. 8 is provided below at least with respect to FIG. 9.

Referring to FIG. 9, a flowchart of a process for generating historical context of the user message through deployment of a memory fusion service is shown according to an embodiment of the disclosure. Each block illustrated in FIG. 9 represents an operation in the process 900 performed by, for example, the memory management engine 106 as shown in FIG. 1. It should be understood that not every operation illustrated in FIG. 9 is required. In fact, certain operations may be optional to complete aspects of the process 900. The discussion of the operations of process 900 may be done so with reference to any of the previously described figures.

The process 900 begins with the memory fusion service 304 obtaining a user message and initial context from the orchestration logic 104 (block 902). As illustrated in FIG. 8, the memory fusion service 304 includes several logic modules that are each configured to obtain data from storage mediums having differing storage architectures include knowledge graphs, traditional databases, cache, etc., and further configured to perform differing types of searches. For clarity, it should be understood that the operations illustrated by blocks 904-912 in FIG. 9 may be performed in any order, may be performed serially, in parallel, or a combination thereof.

Turning to FIGS. 8-9, the knowledge graph RAG logic 800 queries a knowledge graph stored in the knowledge graph database 802 to retrieve nodes related to the user message 122 based on a keyword search using the extracted keywords in the initial context (block 904). As discussed below, the nodes of the knowledge graph include a predefined structure having a repeating set of parameters in each node. As a result, a keyword search may be performed that searches for all nodes having a desired term in a particular parameter. The knowledge graph is configured to store nodes that represent a conversation (or a conversation segment or conversation window as also used hereinto), which provides more accurate information storage as compared to storing information of each message as a node due to the increased context that a conversation provides. A node is formed when a conversation is marked as completed by the conversation boundary service 302. The completed conversation is provided to an LLM with a prompt instructing the LLM to generate one or more nodes from the conversation, where each node has a predefined structure:

```
{
  “entity”: “node”,
  “type”: “emotion”,
  “name”: “stress”,
  “details”: “User experiencing stress due to work deadlines.”,
  “category_l1”: [“Negative Emotions”],
  “category_l2”: [“Work-Related Stress”],
  “references”: [“message_1”, “message_3”]
}
```

In addition to each node having a predefined structure, each node may be one of a predefined node type as provided below. Additionally, the example content provided in each example node is extracted from the following example user input message:
User: “I've been feeling really stressed because of work. It's been non-stop deadlines. I usually go for a run every morning, but I've been skipping it. My boss, Alex, keeps piling on more tasks, and I'm worried I'll burn out. At least my dog, Rocky, helps me relax. He always seems to know when I need a break.”
   Emotions node that tracks emotion states over time, example:

```
{
  “type”: “emotion”,
  “name”: “stress”,
  “details”: “User is experiencing stress
  due to excessive work deadlines.”,
  “category_l1”: [“Negative Emotion”],
  “category_l2”: [“Work-Related Stress”],
  “references”: [“message_1”]
}
```

Daily life node that captures behavioral patterns and disruptions, example:

```
{
  “type”: “daily_life”,
  “name”: “morning routine”,
  “details”: “User typically runs every
  morning but has stopped due to stress.”,
  “category_l1”: [“Habits”],
  “category_l2”: [“Exercise”],
  “references”: [“message_1”]
}
```

Event node that nogs significant disruptions, example:

```
{
  “type”: “event”,
  “name”: “Work deadlines increasing”,
  “details”: “User's workload has intensified, causing stress and habit disruptions.”,
  “category_l1”: [“Life Changes”],
  “category_l2”: [“Career”],
  “references”: [“message_1”]
}
```

Beings node that identifies and categorizes people and sentient entities, example:

```
{
  “type”: “being”,
  “name”: “Alex”,
  “details”: “User's boss who assigns increasing workloads.”,
  “category_l1”: [“People”],
  “category_l2”: [“Coworkers”],
  “references”: [“message_1”]
},
{
  “type”: “being”,
  “name”: “Rocky”,
  “details”: “User's dog, provides emotional support during stress.”,
  “category_l1”: [“Pets”],
  “category_l2”: [“Dogs”],
  “references”: [“message_1”]
}
```

Relationship node that defines relational dynamics between beings, example:

```
{
  “type”: “relationship”,
  “name”: “Boss-Employee”,
  “details”: “User and Alex have a boss-employee relationship.”,
  “references”: [“message_1”]
}
```

Red Flags node that flags concerns requiring a follow-up, example:

```
{
  “type”: “red_flag”,
  “name”: “Burnout Risk”,
  “details”: “User expressed concern
  about excessive workload and stress.”,
  “references”: [“message_1”]
}
```

The nodes may also be categorized into one of a taxonomic node that tracks and categorizes user emotional states and creates time-based relationships enabling a temporal analysis, a content node that tracks beings and nouns in the user's life (entity nodes), monitors daily life patterns and significant events (behavioral), track desires, goals, and potential concerns (psychological), records user preferences and relationship development (identity), or monitors physical and mental wellbeing (health), or a meta node that guides conversation style and support approaches (schema), or creates dynamic semantic groupings of related content (topic).

As is understood by those of ordinary skill in the art, nodes of a knowledge graph are connected through relationship edges that define how different pieces of information relate to each other, creating a rich semantic network that can be traversed to retrieve contextually relevant information. The knowledge graph stored in the knowledge graph database 802 is formed of nodes of any of the types listed above and relationships (edges) between the nodes having one of a predefined set of relationship types including: WITHIN, BELONGS_TO, CAUSED_BY, OCCURS_WITH, IS_BEFORE, IS_DURING, IS_AROUND, IS_AFTER, IS_A, MERGE_WITH, and RELATED_TO. The memory fusion service 304 processes nodes from a conversation and links the nodes through schema-based relationships and/or LLM-generated connections (e.g., nodes are provided to an LLM with a prompt instructing the prompt to define a relationship therebetween in accordance with the predefined set of relationship types). Every node includes a BELONGS_TO relationship with either a user node or an AI persona node. Additionally, the memory fusion service 304 ensures nodes are categorized within schemas and identifies potential duplicates for merging.

Further, the vector search logic 804 is configured to perform a semantic search of past conversational data stored as embeddings in a vector database 806 by transforming the text of the user message 122 into an embedding and performing a similarity search (block 906). In some embodiments, the vector search logic 804 is configured to a semantic search that complements the taxonomic structure of the knowledge graph that is queried by the knowledge graph RAG logic 800. The vector search logic 804 is configured to transform the text of the user message into a high-dimensional vector embedding, perform a similarity search between the vector embedding and vector embeddings stored in the vector database 806, which returns information based in semantic meaning rather than exact keywords. The vector search logic 804 enables the memory fusion service 304 to find relevant information even when the exact terminology differs between the current message and stored information, addressing the limitations of traditional keyword-based retrieval.

Additionally, the conversation summary logic 808 performs a thematic search of LLM-generated summaries of past conversations stored in the conversation summary cache 810 (block 908). The conversation summary logic 808 manages the creation, storage, and retrieval of LLM-generated summaries of past conversations. For example, the conversation summary logic 808 may be configured to generate a brief summary and a comprehensive full summary of each completed conversation and identifies search terms and/or keywords. In some embodiments, the conversation summary logic 808 is an LLM. Additionally, the conversation summary logic 808 may be configured to index the summaries in the conversation summary cache 810 by keyword(s), the messages represented by the summary, related conversation_Id(s), and/or parent conversation_Id(s). The conversation summary logic 808 may also be configured to identify thematically related conversations and retrieve relevant conversation context. In some examples, the conversation summary logic 808 utilizes latent semantic analysis (LSA) and/or natural language processing (NPL) to identify thematically related conversations.

As another operation, the AI persona background logic 812 retrieve a dynamic backstory of an AI persona from the AI persona database and knowledge graph 814 (block 910). The AI persona background logic 812 may generate additional portions of the dynamic backstory based on aspects of the user message and/or retrieved messages. For instance, the user message 122 may inquire about aspects of the backstory of the AI persona that had not been previously generated such as whether the backstory of the AI persona included the care of pets or a death of a loved one (e.g., the backstory is intended to provide a realistic sense that the AI chatbot is representative of a human that is interacting with the user). By dynamically generating aspects of the backstory of the AI persona, the AI persona enables the AI chatbot to be more relatable and realistic to the user compared to current technology that utilizes a static background for a chatbot and may include a canned or default answer when a user message touches an aspect that is not generated as part of a static background.

The AI persona background logic 812 is configured to generate a dynamic backstory generation capability that maintains consistency while enabling expansion of the AI persona's narrative. The AI persona background logic 812 performs operations including maintaining a knowledge graph structure for an AI persona that parallels the knowledge graph of the user, e.g., that knowledge graph stored in the knowledge graph database 802, reviews existing AI persona information when new context is needed and dynamically generates new background details that maintain consistency with established backstory, further the current conversation context, and fill gaps in the history of the AI persona when needed. Additionally. The AI persona background logic 812 validates generated content against existing knowledge and stores new information in the knowledge graph for retrieval by the knowledge graph RAG logic 800 as discussed above. The operations to dynamically maintain an AI persona enables a coherent but expandable history (backstory), which is a technical improvement over current technologies that utilize static, predefined backstories. Additionally, as the backstory of the AI persona is stored as a knowledge graph, the AI persona background logic 812 may retrieve semantically and thematically rich information to provide to the LLM for generation of a response to a user message.

Even further, the cached summary logic 816 retrieves cached contextual summaries of relevant nodal cluster of past conversations (block 912). In some examples, a nodal cluster may comprise a pre-computed cluster of nodes that correspond to summaries of conversations that occurred in the morning, e.g., a predefined hour range, which may include 12:00 am-11:59 am (which represents a temporal context cluster as noted below). Additionally, the cached summary retrieval logic 816 implements an optimization layer that pre-computes frequently needed information summaries by generating contextual summaries of node clusters based on temporal context (morning conversations, weekend interactions), topical context (work discussions, relationship conversations), emotional context (conversations during specific emotional states), and schema context (advice sessions, emotional support exchanges). Further, the cached summary logic 816 updates cached summaries in response to the additional of substantive information. From a purely technical perspective, the cached summary logic 816 and its corresponding functionality provide a caching mechanism that significantly improves system performance by reducing the need to process large volumes of raw data in real time for common retrieval patterns while still maintaining context awareness.

In general, the operations performed by the memory fusion service 304 integrate outputs from the five logic modules (sub-components) illustrated in FIG. 8 through a dedicated LLM process that resolves potential conflicts between different information sources, prioritizes information based on relevance to the current context, creates a coherent narrative from diverse memory fragments, and packages the integrated memory context for consumption by the orchestration logic 104 and/or the LLM 110₁. The operations may include a combination of server-side logic, e.g., case statements, if/else statements, etc., and one or more prompts to an LLM. As an example, a first operation may include filtering down the database information. For each of the key terms in the initial context that an LLM called indicated as needing memory backup (e.g., search terms chosen to need more information or context) and filtering down the amount of data passed (e.g., limiting nodes to a number of most used nodes by sorting them by the number of relationships each node has) to maximize context while keeping tokens/nodes manageable (e.g., returns a set of nodes). A second operation may include passing the set of nodes to an LLM, which analyzes the retrieved information for inconsistencies, logic, and relation to the user 122 message and generates a single memory object that may be provided to the orchestration logic 104 and to the LLM 110₁.

### IV. Architecture and Operational Flows-Dynamic AI Persona Management Engine

Referring now to FIG. 10, an architecture diagram of a dynamic AI persona management engine 108 is shown according to an embodiment of the disclosure. The dynamic AI persona management engine 108 is shown to be comprised of a plurality of logic modules some of which may be configured to access a persona profile database 1006. In particular, the dynamic AI persona management engine 108 includes a persona generation logic 1002, a persona persistence logic 1004, and a user input message processing logic 1018. The persona generation logic 1002 may be configured to receive initial user input, e.g., at account set-up time or, more specifically, upon generation of an AI persona as a user account may be associated with multiple AI personas (e.g., a persona that mimics a therapist, a persona that mimics a personal trainer, etc.). In response to the initial user input, the persona generation logic 1002 is configured to generate an AI persona as discussed with respect to FIG. 11. As shown, the AI persona generation logic 1004 may access sub-storage components of the persona profile database 1006 including a traits component 1008, a moral framework component 1010, a backstory component 1012, an adaptive parameters component 1014, and an identity persistence rules component 1016.

The persona persistence logic 1004 is configured to maintain a consistent identity for each AI persona. For example, the persona persistence logic 1004 is configured to identify and preserve defining characteristics (e.g., protect core traits of the AI persona from change), prevent out-of-character behaviors through application of boundary enforcement rules, and perform regular alignment checking (e.g., at set intervals) through application of a set of consistency verification protocols, which may be a predefined set of rules in some examples. Additionally, the persona persistence logic 1004 may be configured to address identity drift through coherence restoration methods, e.g., which also may be predefined rules or logic for restoring data forming an AI persona to or toward values that were provided through or generated as a result of the initial user input when generating the AI persona. The persona persistence logic 1004 may also determine an identity confidence score for an AI persona by determining metrics for consistency measurement, where a score below a threshold may trigger application of a coherence restoration method. In some examples, the logic and rules performed by the persona persistence logic 1004 may be performed by logic running on a server or other computing resources (e.g., on which the AI platform 101 is running) and include transmission of prompts to one or more LLMs. Generally, the operations of the persona persistence logic 1004 are intended to ensure that the AI persona maintains a recognizable identity even as it adapts to interactions and experiences. In some instances as discussed with respect to FIG. 13, the AI platform 101 may operate on a network device of a user with one or more LLMs processing locally on the network device.

The user input message processing logic 1018 is comprised of sub-modules including a persona baseline retrieval logic 1020, a dynamic persona state engine 1022, a situational adaptation engine 1024, and a dynamic expression service 1026. The persona baseline retrieval logic 1020 is configured to retrieve a baseline AI persona from the persona profile database 1006 in response to receipt of the user message 122 and the initial context 300. The AI persona may be retrieved based on metadata of the user message 122, which include a user identifier or an account identifier, either of which may be indicatives of a particular user and corresponding AI persona. The retrieved AI persona may be comprised of values for a set of trait parameters and moral framework parameters and/or text comprising a backstory and/or nodes forming a knowledge graph.

The dynamic persona state engine 1022 is configured to implement a system for tracking and evolving the AI persona's emotional state including core emotion tracking that is performed by real-time numerical tracking (e.g., tracking and adjusting numerical values such as on a scale from 1-10) of parameters representing a set of primary emotions and quantifying emotional intensity based on values of the parameters. The dynamic persona state engine 1022 may monitor state persistence by applying appropriate decay rates to adjustments of the numerical values of parameters. Generally, the methodology of the dynamic persona state engine 1022 includes retrieving an AI persona, which is at a baseline emotional state (represented numerically) and adjusts the numerical values representing the emotional state based on factors extracted from the user message 122 and external factors, e.g., time of day, conversational tone, usage frequency, topic discussed, etc. The final numerical values of the adjusted AI persona are provided as input to a wording method that generates LLM-friendly wording for the new state of the AI persona that can be passed on in the message generation process.

Additionally, dynamic persona state engine 1022 is configured to implement state transition mechanics that include applying personality-weighted transition rules such as trait-based resistance to certain emotional shifts, characteristic recovery patterns from negative emotions, and emotional trigger sensitivity thresholds. Additionally, the state transition mechanics may include natural decay algorithms specific to each emotion, emotion blending mechanics for mixed states, and transition inhibition during ongoing interactions. The state transition mechanics may be comprised of various predetermined rule sets that assess an adjustment of the AI persona and subtly adjust the values of parameters forming the AI persona back toward to the baseline numerical values.

The situational adaptation engine 1024 may be configured to implement a system for adapting communication based on situational factor such as conversation schema recognition (recognition of interaction types where non-exhaustive examples include: advice/guidance scenarios, emotional support contexts, information exchange, casual conversation, professional interaction) and apply schema-specific communication adjustment rules and context-appropriate formality calibration. Additionally, the situational adaptation engine 1024 may be configured to recognize relationship development phases, progressive intimacy adjustments. In view of such, the adaptation engine 1024 may apply trust-based communication modifications and boundary management. This situational adaptation engine 1024 enables the AI persona to adapt appropriately to different situations while maintaining their fundamental identity and style.

Additionally, the situational adaptation engine 1024 may perform contextual influence processing that includes applying time-based modifiers (time of day, day of week) and/or topic-specific emotional adjustments to the parameter values comprising the AI persona. In some examples, the dynamic persona state engine 1022 may apply event-triggered emotional responses such as adjustments of the parameter values based on events identified in a user message (e.g., death of a user's loved one). In some examples, the adjustments may result in cumulative interaction effects.

The dynamic expression service 1026 is configured to adjust one or more parameters of a baseline AI persona based on the initial context of the user message. For instance, a sentiment analysis may be performed by a LLM as part of the preprocessing operations, which results in a determination of a numerical value for a predetermined set of emotion and tone parameters, such as emotions of happiness, sadness, anger, cheerful, etc. One or more parameter (each corresponding to a single emotion) may be adjusted based on the sentiment analysis, e.g., a default 5/10 numerical score for sadness may be adjusted to 10/10 when the user message indicates a death of a loved one.

Referring now to FIG. 11, a flowchart of a process for generating a baseline AI persona to be dynamically altered based on a user message and external factors prior to providing to an AI chatbot configured to generate a response to the user message is shown according to an embodiment of the disclosure. Each block illustrated in FIG. 11 represents an operation in the process 1100 performed by, for example, the persona generation logic 1004 as shown in FIG. 10. It should be understood that not every operation illustrated in FIG. 10 is required. In fact, certain operations may be optional to complete aspects of the process 1100. The discussion of the operations of process 1100 may be done so with reference to any of the previously described figures.

The process 1100 begins with receipt of user input corresponding to at least a portion a set of input variables for the generation of an AI persona for an instance of an AI chatbot (block 1102). The persona generation logic 1004 determines whether the user input is missing one or more variables from the set of input variables (block 1104). For example, a user may access a graphical user interface (GUI) generated by the AI platform 101 that includes various user input (UI) components such as text boxes, dropdown menus, radio buttons, etc., such that each of the set of input variables are associated with one or more UI components. When the user input is received via the GUI, the persona generation logic 1004 parses and when user input was not received for one or more input variables (i.e., a user opted not to provide input to a corresponding UI component), the persona generation logic 1004 generates and transmits a prompt to an LLM that instructs the LLM to generate the missing variables that are consistent with the received user input (block 1106). The remainder of the input variables are received in an LLM response, and a second prompt is then provided to an LLM to generate a backstory for the AI persona consistent with the user input variables including the AI-generated variables (blocks 1108, 1110).

Similarly, when input variables are not missing (no at block 1104), the second prompt is then provided to the LLM to generate a backstory for the AI persona consistent with the user input variables (blocks 1108, 1110). In some instances, the user account may be configured such that the user is to approve the AI-generated backstory before proceeding (block 1112). When the user is to approve and the user did not approve (yes at block 1112 and no at block 1114), a prompt is again provided to the LLM to generate a backstory for the AI persona consistent with the input variables (block 1110). In such an instances, the prompt may provide the previously generated backstory with an instruction to avoid similar facts. When the user does not have to approve the backstory (no at block 1112) or approved (yes at block 1114), a prompt is provided to the LLM to generate a referential writing style based on the user input and AI-generated variables (block 1116).

The generation of a referential writing style framework establishes consistent communication patterns by mapping the AI persona's personality to literary references. In some embodiments, this process includes operations of processing the complete AI persona profile based on the user input variables and AI-generated input variables to extract key character information including demographic attributes (name, age, gender, race), role classification, personality traits, skills and capabilities, backstory elements, purpose/function, and consolidates this information into a comprehensive character profile for style analysis. The consolidation may include application of logic to translate structured data into natural language, readable text.

The process of generating the referential writing style further includes mapping the AI persona profile to literary and stylistic references based on user input. For example, user input may be received corresponding to selection of a reference author for each of four distinct writing style components: sentence structure and grammar; tone and voice; vocabulary and expression; and pacing and rhythm.

The process of generating the referential writing style further includes generating a structured style reference framework (the writing style) that includes an author reference for each style component, an explicit reasoning for why each author's style matches the AI persona, specific stylistic elements to emulate from each reference, and guidelines to ensure natural, contemporary expression. The framework may then be stored in a structured JSON format.

This referential approach provides multiple advantages over direct rule specification as the referential approach encodes complex stylistic patterns through literary shorthand, creates a flexible yet consistent foundation for expression, provides human-interpretable style definitions, enables more nuanced adaptation to different contexts, and facilitates more efficient style transfer than exhaustive rule sets.

In addition to the framework, the writing style may be structured into four primary subcomponents, each with specific attributes and implementation guidelines. First, a sentence structure subcomponent defines the grammatical patterns and structural characteristics of the AI persona's communication, sentence length distribution (statistical parameters for typical, minimum, and maximum sentence lengths), clause complexity patterns (tendencies toward simple, compound, or complex structures), subordination preferences (frequency and type of subordinate clauses), transition patterns (characteristic ways of connecting thoughts and sentences), and grammar flexibility (permissible deviations from standard grammar rules). These parameters establish a recognizable structural foundation for the AI persona's writing style while allowing for natural variations.

Second, a tone and voice component defines the emotional and personality qualities expressed through language: a formality spectrum (baseline formality level with contextual modifiers), an emotional expressiveness (degree of emotional transparency in language), personality markers (linguistic elements that convey personality traits), intimacy calibration (warmth and distance parameters), and distinctive voice characteristics (unique elements that create recognizability). This creates a consistent “feel” to the AI persona's communication that remains identifiable across different contexts and emotional states.

Third, a vocabulary subcomponent defines word choice patterns and expressions: a lexical complexity (vocabulary sophistication level), domain-specific terminology (specialized vocabulary based on background), idiom usage (frequency and type of idiomatic expressions), metaphor preferences (characteristic figurative language patterns), word origin preferences (tendencies toward certain linguistic roots), and a cultural reference framework (sources and types of cultural references). These parameters create a distinctive and consistent vocabulary profile that reflects the AI persona's background and personality.

Fourth, a pacing and rhythm subcomponent defines how information is structured and delivered: information density (typical amount of content per message unit), rhythm patterns (characteristic flow of long and short elements), emphasis techniques (methods for highlighting important information, pause utilization (strategic use of breaks in communication), and topic transition style (characteristic ways of changing subjects). These elements create a recognizable cadence and flow to the AI persona's communication style. In some examples, an LLM may be prompted to perform the structuring of the writing style into the subcomponents.

Following the generation of a writing style, the LLM is prompted yet again with instructions to generate a baseline mood based on the user input variables (and any AI-generated variables), where the baseline mood is comprised of a set of parameters with each being representative of an emotion and associated with a numerical value (block 1118). For example, when the user input indicates that the AI-persona is to have a cheery, optimistic outlook on life, the baseline mood for the AI persona will have higher numerical values for parameters corresponding to optimism, happiness, cheerfulness, etc., and lower numerical values for parameters corresponding anger, sadness, etc. As should be understood from the disclosure here, upon receipt of a user message, the dynamic AI persona management engine 108 generates a dynamic expression of the AI persona by adjusting the parameter values corresponding to these emotions based on the tone, mood, content, etc., that is stated or conveyed in the user message. For example, a user message that conveys a tone of anger over events in the user's life will result in decreasing the parameters values for optimism and cheerfulness slightly such that, when provided to an LLM with instructions to generate a response to the user message in accordance with the dynamic expression of the AI persona, the LLM will provide a response in an appropriate tone that conveys a sense of understanding to the user's anger.

Returning back to FIG. 11, following the generation of the baseline mood, an AI persona object is generated from the user input, AI-generated variables, the backstory, referential writing style, and baseline mood (block 1120). This may be stored in a database, such as the AI persona database and knowledge graph 814 of FIG. 8. In some examples, the AI persona object is stored in a knowledge graph.

Referring to now FIG. 12, a flowchart of a process for altering a baseline AI persona and a baseline writing style of the AI persona based on a received user message and external factors is shown according to an embodiment of the disclosure. Each block illustrated in FIG. 12 represents an operation in the process 1200 performed by, for example, the dynamic AI persona management engine 108 as shown in FIG. 1. It should be understood that not every operation illustrated in FIG. 12 is required. In fact, certain operations may be optional to complete aspects of the process 1200. The discussion of the operations of process 1200 may be done so with reference to any of the previously described figures.

The process 1200 begins with obtaining, by a user input message processing logic 1018, a user input message (user message) and initial context generated in part from pre-processing of the user message, where the initial context includes extracted raw message text, metadata (such as a conversation_Id and a timestamp), and extracted keywords (block 1202).

The process 1100 continues with retrieving, by a persona baseline retrieval logic 1020, a baseline AI persona from a persona profile database 1006 (block 1204). The persona profile database 1006 may include sub-storage components including a traits component 1008, a moral framework component 1010, a backstory component 1012, an adaptive parameters component 1014, and an identity persistence rules component 1016.

The dynamic persona state engine 1022 may then dynamically alter the baseline AI persona based on the initial context and external factors to adjust the personality with which an LLM is to craft a response to the user message (block 1206).

Following alteration of the baseline AI persona, situational adaptation factors may be generated based on the user message and initial context (block 1208).

A dynamic expression is then generated for the AI persona by integrating a baseline writing style of the AI persona with the altered baseline AI persona and external factors (block 1210). In one embodiment, the results of adjusting the baseline AI persona following the processing by the dynamic persona state engine 1022, the situational adaptation engine 1024, and the dynamic expression service 1026 are processed through a series of predetermined rules resulting in a text description of the AI persona that reflects the adjustment of the baseline AI persona according to the initial context 300 (mood, tone, content, etc.), a current state of the AI persona (reflecting prior adjustments in view of decay rates), and external factors (e.g., time of day). The processing with the series of predetermined rules results in generation of the dynamic expression of the AI persona, which is configured to be provided to the LLM.

The dynamic expression is provided to the orchestration logic 302, which generates a prompt for the LLM based on the dynamic expression as well as the user message 122, initial context 300, a decision by the conversation boundary service 304, and historical context generated by the memory fusion service 306 (block 1212). The prompt is then transmitted to the LLM, which processes the prompt and returns a response, which is in turn returned to a network device of the user (block 1214). For example, the response may be displayed on a display screen of the network device in the form of a chat interface.

### V. Logical Representation

Referring now to FIG. 13, an example logical representation illustrating logic components of the dynamic AI persona platform of FIG. 1 is shown according to an embodiment of the disclosure. In the example shown in FIG. 13 a networking device 1300 includes one or more processors 1302 that is communicatively coupled to a communication interface 1304 and storage 1306, which may be non-transitory computer readable medium. The storage 1306 may have stored thereon logic, e.g., in the form of computer-executable instructions, that, when executed by the processor 1302, cause the processor 1302 to perform the methods described herein.

As used herein, one implementation of a computing device may be a server device that has a memory for storing program code instructions and a hardware processor for executing the instructions. The server device can further include other physical components, such as a network interface or components for input and output. The storage 1306 may include components that collectively may be referred to as a dynamic AI persona platform (or AI platform) 101, which includes pre-processing logic 102, an orchestration logic 104, a memory management engine 106, a dynamic AI persona management engine 108, and optionally, a machine learning (ML) model storage 1308 that may be configured to store one or more LLMs or other machine learning models discussed in this disclosure. For instance, the dynamic AI persona platform 101 may be configured to operate solely on a network device of a user, e.g., a laptop, tablet, mobile device, etc., where LLMs called by the logic modules comprising the AI platform 101 operate locally on the network device.

Additionally, the AI platform 101 may also include various data stores as needed to store data discussed above and, for example, may include specific data stores such as a ML model storage 1308 as well as any of the datastores illustrated in other figures. In some examples, the datastores may be stored elsewhere and be accessible to the AI platform 101. Examples of such storage include non-transitory computer-readable mediums, such as a magnetic or optical storage disk or a flash or solid-state memory, from which the program code can be loaded into the memory of the network device 1400 for execution. The term “non-transitory” refers to retention of the program code by the computer-readable medium while not under power, while volatile or “transitory” memory or media requires power in order to retain data.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, data stores can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a computing device for execution thereby resulting in performance of the operations described in the flow chart by one or more components of the networked environments illustrated or described herein. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

What is claimed is:

1. A computer-implemented method, comprising:
receiving a user message from a user as user input to a graphical user interface, wherein the user message corresponds to a query or a statement to with an artificial intelligence (AI) chatbot;
performing preprocessing operations on the user message resulting in generation of initial context of the user message by extracting text of the user message, metadata of the user message, and a conversation identifier;
obtaining historical context pertaining to the user message from a plurality of storage mechanisms provided in differing formats including a knowledge graph, a vector database comprised of vector embeddings, and a database comprising text summaries of prior conversations between the user and the AI chatbot;
generating a prompt for a large language model (LLM) that instructs the LLM to generate a response to the user message that is based on and consistent with the user message, the initial content, and the historical context;
transmitting the prompt to the LLM; and
providing a final response to the user that is corresponds to an LLM-generated response.

2. The computer-implemented method of claim 1, wherein the graphical user interface is a chat interface, and wherein the final response is provided as a text message within the chat interface, wherein the chat interface is displayed on a display screen of a network device.

3. The computer-implemented method of claim 1, wherein the preprocessing operations include:
generating a second prompt for a second LLM instructing the second LLM to perform sentiment analysis resulting in determination of a numerical value for a predetermined set of emotion and tone parameters, wherein the initial context includes a result of the sentiment analysis.

4. The computer-implemented method of claim 1, wherein transmitting the prompt to the LLM includes transmitting the prompt over a network using one or more application programming interface (API) calls.

5. The computer-implemented method of claim 1, wherein the knowledge graph is comprised of a set of nodes representing past messages or past conversations between the user and the AI chatbot, wherein the set of nodes of interconnected through a set of edges defining how nodes relate to each other.

6. The computer-implemented method of claim 1 further comprising:
prior to generating the prompt for the LLM, generating a conversation boundary decision indicating whether the user message forms an extension of an existing conversation between the user and the AI chatbot or forms a new conversation.

7. The computer-implemented method of claim 1 further comprising:
prior to generating the prompt for the LLM, retrieving a baseline AI persona from a persona database or a persona knowledge graph; and
dynamically adjusting parameters of the baseline AI persona based on the user message, initial context, and external factors resulting in an adjusted AI persona, wherein generating the prompt for the LLM is performed in accordance with the adjusted AI persona resulting in instructions for the LLM to generate the LLM-generated response based on adjusted parameters.

8. The computer-implemented method of claim 7, wherein each parameter of the adjusted parameters of the adjusted AI persona corresponds to a numerical value representing an emotion or a tone with which generation of the LLM-generated response is to be consistent.

9. A computing device, comprising:
a processor; and
a non-transitory computer-readable medium including configuration logic and a rules engine that, when executed by the processor, cause the configuration logic to perform operations including:
receiving a user message from a user as user input to a graphical user interface, wherein the user message corresponds to a query or a statement to with an artificial intelligence (AI) chatbot,
performing preprocessing operations on the user message resulting in generation of initial context of the user message by extracting text of the user message, metadata of the user message, and a conversation identifier,
obtaining historical context pertaining to the user message from a plurality of storage mechanisms provided in differing formats including a knowledge graph, a vector database comprised of vector embeddings, and a database comprising text summaries of prior conversations between the user and the AI chatbot,
generating a prompt for a large language model (LLM) that instructs the LLM to generate a response to the user message that is based on and consistent with the user message, the initial content, and the historical context,
transmitting the prompt to the LLM, and
providing a final response to the user that is corresponds to an LLM-generated response.

10. The computing device of claim 9, wherein the graphical user interface is a chat interface, and wherein the final response is provided as a text message within the chat interface, wherein the chat interface is displayed on a display screen of a network device.

11. The computing device of claim 9, wherein the preprocessing operations include:
generating a second prompt for a second LLM instructing the second LLM to perform sentiment analysis resulting in determination of a numerical value for a predetermined set of emotion and tone parameters, wherein the initial context includes a result of the sentiment analysis.

12. The computing device of claim 9, wherein transmitting the prompt to the LLM includes transmitting the prompt over a network using one or more application programming interface (API) calls.

13. The computing device of claim 9, wherein the knowledge graph is comprised of a set of nodes representing past messages or past conversations between the user and the AI chatbot, wherein the set of nodes of interconnected through a set of edges defining how nodes relate to each other.

14. The computing device of claim 9, wherein the operations further include:
prior to generating the prompt for the LLM, generating a conversation boundary decision indicating whether the user message forms an extension of an existing conversation between the user and the AI chatbot or forms a new conversation.

15. The computing device of claim 9, wherein the operations further include:
prior to generating the prompt for the LLM, retrieving a baseline AI persona from a persona database or a persona knowledge graph; and
dynamically adjusting parameters of the baseline AI persona based on the user message, initial context, and external factors resulting in an adjusted AI persona, wherein generating the prompt for the LLM is performed in accordance with the adjusted AI persona resulting in instructions for the LLM to generate the LLM-generated response based on adjusted parameters.

16. The computing device of claim of claim 15, wherein each parameter of the adjusted parameters of the adjusted AI persona corresponds to a numerical value representing an emotion or a tone with which generation of the LLM-generated response is to be consistent.

17. A non-transitory storage medium having stored thereon instructions that, when executed by one or more processors, cause the one or more processor to perform operations comprising:
receiving a user message from a user as user input to a graphical user interface, wherein the user message corresponds to a query or a statement to with an artificial intelligence (AI) chatbot;
performing preprocessing operations on the user message resulting in generation of initial context of the user message by extracting text of the user message, metadata of the user message, and a conversation identifier;
obtaining historical context pertaining to the user message from a plurality of storage mechanisms provided in differing formats including a knowledge graph, a vector database comprised of vector embeddings, and a database comprising text summaries of prior conversations between the user and the AI chatbot;
generating a prompt for a large language model (LLM) that instructs the LLM to generate a response to the user message that is based on and consistent with the user message, the initial content, and the historical context;
transmitting the prompt to the LLM; and
providing a final response to the user that is corresponds to an LLM-generated response.

18. The non-transitory storage medium of claim 17, wherein the graphical user interface is a chat interface, and wherein the final response is provided as a text message within the chat interface, wherein the chat interface is displayed on a display screen of a network device.

19. The non-transitory storage medium of claim 17, wherein the preprocessing operations include:
generating a second prompt for a second LLM instructing the second LLM to perform sentiment analysis resulting in determination of a numerical value for a predetermined set of emotion and tone parameters, wherein the initial context includes a result of the sentiment analysis.

20. The non-transitory storage medium of claim 17, wherein the operations further include:
prior to generating the prompt for the LLM, retrieving a baseline AI persona from a persona database or a persona knowledge graph; and
dynamically adjusting parameters of the baseline AI persona based on the user message, initial context, and external factors resulting in an adjusted AI persona, wherein generating the prompt for the LLM is performed in accordance with the adjusted AI persona resulting in instructions for the LLM to generate the LLM-generated response based on adjusted parameters, and wherein each parameter of the adjusted parameters of the adjusted AI persona corresponds to a numerical value representing an emotion or a tone with which generation of the LLM-generated response is to be consistent.
